(19) United States
(12) Patent Application Publication
(10) Pub. No.: US 2012/0257150 A1
(43) Pub. Date: Oct. 11, 2012

(54) LIQUID CRYSTAL DISPLAY PANEL

(76) Inventor: Chien-Hao Wu, Tainan City (TW)

(21) Appl. No.: 13/224,343

(22) Filed: Sep. 2, 2011

(30) Foreign Application Priority Data
Apr. 11, 2011 (TW) 100112447

(51) Int. Cl. G02F 1/1335

(52) U.S. Cl. 349/106

(57) ABSTRACT

A liquid crystal display includes a thin-film transistor (TFT) array substrate, a color filter substrate and a liquid crystal layer disposed between the TFT array substrate and the color filter substrate. The TFT array substrate includes a first substrate, a plurality of scan lines, a plurality of data lines, a plurality of pixel electrodes and a black matrix layer. The black matrix layer is disposed above the scan lines and the data lines of the TFT array substrate and between the data lines and the pixel electrodes.

### BACKGROUND OF THE INVENTION

1. Field of the Invention

The present invention relates to a liquid crystal display panel, and more particularly, to a liquid crystal display panel having a high aperture ratio.

2. Description of the Prior Art

Thin-film transistors (TFTs) are commonly used as active components in active matrix display panels including active matrix liquid crystal displays and active matrix organic electroluminescent display panels. A conventional active matrix liquid crystal display includes a thin-film transistor (TFT) array substrate, a color filter substrate, and a liquid crystal layer interposed between the two.

Please refer to FIG. 1, which illustrates pixel regions of a TFT array substrate according to the prior art. As shown in FIG. 1, a pixel region 10 includes a plurality of data lines 11, a plurality of scan lines 12 crossing the data lines 11 in the form of a grating, a pixel electrode 13 surrounded by the data lines 11 and the scan lines 12, and a TFT 14. To meet the requirement of enlarging the display panel size and achieving higher resolution, the length of the data lines and the scan lines, the number of data lines and scan lines, and the driving frequency all tend to increase. The resultant smaller intervals between neighboring data lines, scan lines and pixel electrodes may induce cross talk, however. If the interval between a pixel electrode and a corresponding data line is broadened to eliminate cross talk, the area of the pixel electrode may be narrowed. Accordingly, the aperture ratio lowers, the light-leaking region extends and the consuming power increases.

Please refer to FIG. 2, which illustrates a liquid crystal display according to the prior art. As shown in FIG. 2, the conventional liquid crystal display 20 includes a TFT array substrate 21, a color filter substrate 22 and a liquid crystal layer 23. The liquid crystal layer 23 is disposed between the TFT array substrate 21 and the color filter substrate 22. The TFT array substrate 21 includes a glass substrate 24, a plurality of data lines 25, a plurality of scan lines (not shown), a plurality of pixel regions 26, a plurality of TFTs (not shown), a protective layer 27 and a plurality of pixel electrodes 28. Furthermore, the color filter substrate 22 disposed parallel to the TFT array substrate 21 includes a glass substrate 29, a plurality of black matrix units 22a, a plurality of color filter units 22b, a protective layer 22c and a common electrode 22d. The black matrix units 22a and the color filter units 22b are partially overlapped for blocking leaking light L from the edge of the pixel electrode 28. Additionally, in order to compensate for the alignment deviation when assembling the TFT array substrate 21 and the color filter substrate 22, as shown by the region A in FIG. 2, the black matrix units 22a are arranged to overlap the periphery regions of the pixel electrodes 28. Consequently, the aperture ration may be adversely impacted.

### SUMMARY OF THE INVENTION

An objective of the present invention is therefore to provide a liquid crystal display panel that improves the aperture ratio.

According to one exemplary embodiment of the present invention, a liquid crystal display is provided. The liquid crystal display includes a thin-film transistor (TFT) array substrate, a color filter substrate and a liquid crystal layer. The TFT array substrate includes a first substrate, a plurality of scan lines, a plurality of data lines, a plurality of pixel regions and a black matrix layer. The scan lines are arranged along a first direction on the first substrate, while the data lines are arranged along a second direction on the first substrate, and the second direction crosses the first direction. The pixel regions surrounded by the scan lines and the data lines include a plurality of pixel electrodes and a plurality of TFTs, and the pixel electrodes are electrically connected to the respective drain electrodes of the TFTs. The black matrix layer is disposed above the scan lines and the data lines and interposed between and the data lines and the pixel electrodes. The color filter substrate disposed opposite to the TFT array substrate includes a second substrate and a color filter layer, and the color filter layer is disposed on a surface of the second substrate. Furthermore, the liquid crystal layer is disposed between the TFT array substrate and the color filter substrate.

In the present invention, on the TFT array substrate, the black matrix layer is disposed above the scan lines and the data lines, and between the data lines and the pixel electrodes. The TFT array substrate is later combined with the color filter substrate to form the liquid crystal display. The black matrix layer and the pixel electrodes are all arranged on the TFT array substrate so that the area of the black matrix layer which overlaps the periphery regions of the pixel electrodes for compensating the alignment deviation could be decreased. Accordingly, the redundant light shielding area of the black matrix layer may be reduced in order to increase the aperture ratio of the liquid crystal display panel. Additionally, the black matrix layer has a thickness and a dielectric constant (substantially between 3 and 4) smaller than a dielectric constant (substantially between 6 and 8) of the conventional protective layer. Due to the disposition of the black matrix layer, the edges of the pixel electrodes could be extended to cover the data lines, and therefore the horizontal distance between the pixel electrodes and the data lines may be decreased for reducing the possible light-leaking region. Moreover, the thickness of the black matrix layer having a lower dielectric constant may increase the vertical distance between the pixel electrodes and the data lines for eliminating the coupling capacitance between the pixel electrodes and the data lines/the scan lines, and further for stabilizing the peripheral electric field of the pixel electrodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates pixel regions of a TFT array substrate according to the prior art.

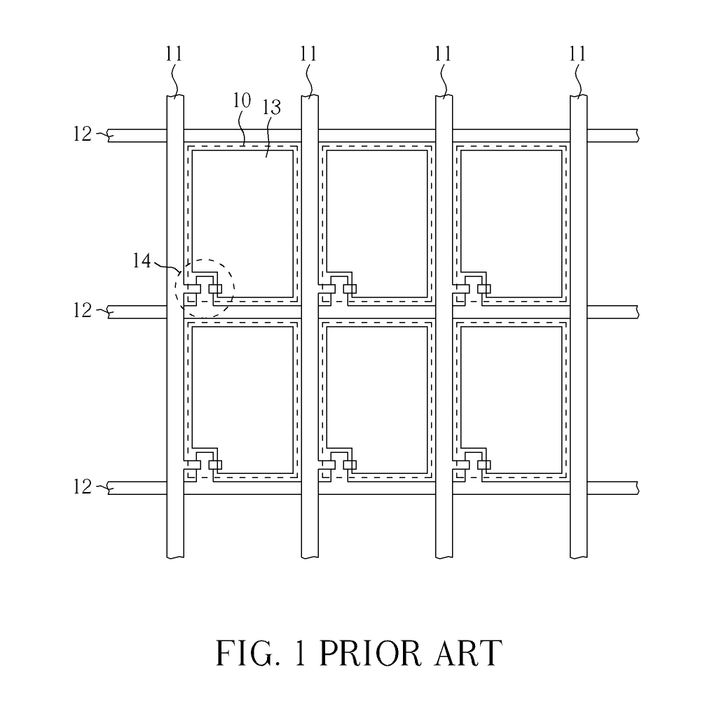

FIG. 2 illustrates a liquid crystal display according to the prior art.

FIG. 3 illustrates a thin-film transistor (TFT) array substrate according to an exemplary embodiment of the present invention.

FIG. 4 is a cross-sectional view illustrating the TFT array substrate taken along the line BB' of FIG. 3 according to an exemplary embodiment of the present invention.

FIG. 5 illustrates a liquid crystal display panel according to an exemplary embodiment of the present invention.

### DETAILED DESCRIPTION

To provide a better understanding of the present invention, preferred exemplary embodiments will be described in detail herein. The preferred exemplary embodiments of the present invention are illustrated in the accompanying drawings with numbered elements.

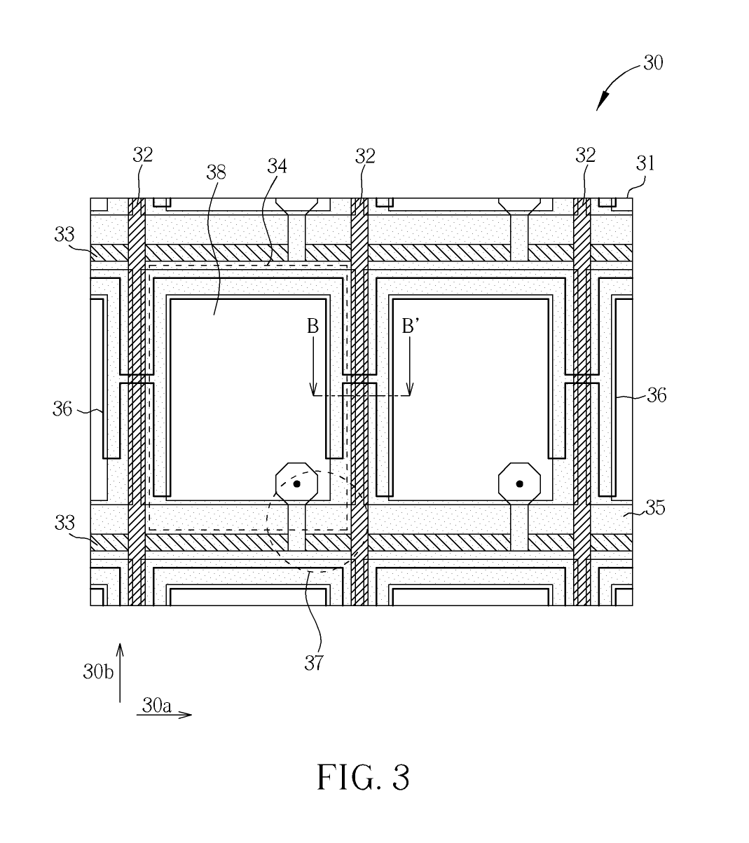

Please refer to FIG. 3. FIG. 3 illustrates a thin-film transistor (TFT) array substrate 30 according to an exemplary embodiment of the present invention. The TFT array substrate 30 includes a first substrate 31, a plurality of data lines 32, a plurality of scan lines 33, a plurality of pixel regions 34, a black matrix layer 35 and a metal layer 36. The scan lines 33 are arranged parallel to each other along a first direction 30a on the first substrate 31. The data lines 32 are arranged parallel to each other along a second direction 30b on the first substrate 31, and the second direction 30b crosses the first direction 30a. The pixel regions 34 are defined as the regions surrounded by the scan lines 33 and the data lines 32. Each of the pixel regions 34 at least includes a TFT 37 and a pixel electrode 38. The pixel electrode 38 is electrically connected to the drain electrode (not shown) of the TFT 37. The TFT 37 disposed on the first substrate 31 may be a TFT having a top gate structure or a bottom gate structure, but is not limited thereto.

It should be appreciated that the black matrix layer 35 of the TFT array substrate 30 is disposed above the scan lines 33 and the data lines 32, and between the data lines 32 and the pixel electrodes 38. The pixel electrode 38 partially overlaps the black matrix layer 35. Additionally, each of the pixel regions 34 includes the metal layer 36, and the metal layer 36 is electrically connected along a first direction 30a on the first substrate 31. In the pixel regions 34, the metal layer 36 is disposed in a U-shape, and the black matrix layer 35 partially overlaps the metal layer 36. The structure of the metal layer 36 is not limited to being U-shaped and other shapes such as linear or H-shapes are suitable to be used as well. Furthermore, the metal layer 36 may be a floating metal layer or electrically connected to a common voltage.

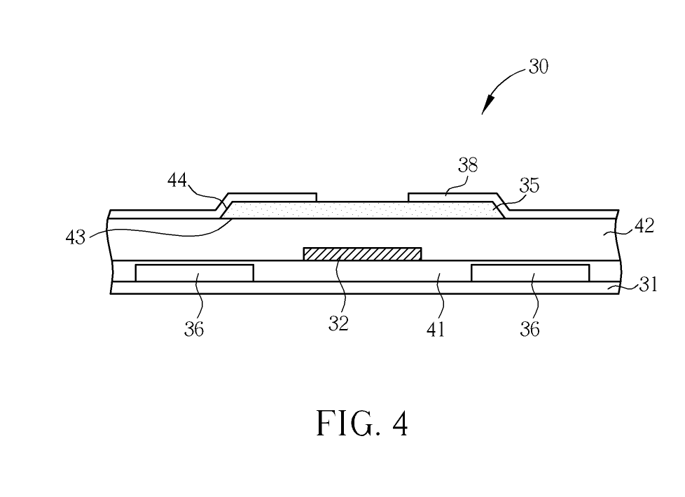

Please refer to FIG. 4. FIG. 4 is a cross-sectional view illustrating TFT array substrate taken along the line BB′ of FIG. 3 according to an exemplary embodiment of the present invention. As shown in FIG. 4, the TFT array substrate 30 includes the first substrate 31, the metal layer 36, a gate insulating layer 41, the data line 32, a protective layer 42, the black matrix layer 35 and the pixel electrode 38. The process for manufacturing the TFT array substrate 30 includes the steps detailed below, and the TFT having the bottom gate structure is taken as an example. At first, a first metal layer (not shown) is formed on the first substrate 31, and the first metal layer is patterned for forming a plurality of scan lines 33 (not shown) and the metal layer 36. Then, the gate insulating layer 41, a semiconductor layer (not shown) and a patterned stop layer (not shown) are formed sequentially. Subsequently, a second metal layer (not shown) is formed and patterned as a plurality of data lines 32 and a plurality of drain electrodes (not shown), and the protective layer 42 is later formed. Furthermore, the protective layer 42 is etched to form a plurality of through holes (not shown), and a plurality of pixel electrode 38 are formed to be electrically connected to the respective drain electrodes (not shown) by the through holes. These process steps are commonly known to those skilled in the art in this field, and therefore further details are omitted herein for brevity. It should be appreciated that the process for manufacturing the TFT array substrate 30 further includes the step of forming the black matrix layer 35. The black matrix layer 35 is formed above the surface of the protective layer 42 covering the data lines 32 and the scan lines (not shown in FIG. 4), and this step is preferably performed after the formation of the protective layer 42 and before the formation of the pixel electrodes 38.

The data lines 32 made of opaque conductive materials are arranged parallel to each other along the direction vertical to the paper surface on the first substrate 31. The pixel regions (not shown in FIG. 4) are the regions surrounded by the scan lines and the data lines on the first substrate 31. Each of the pixel regions at least includes a thin-film transistor (not shown in FIG. 4) disposed on the first substrate 31, and further includes the pixel electrode 38 and the metal layer 36. The gate insulating layer 41 disposed on the first substrate 31 covers the scan lines (not shown in FIG. 4) and the metal layer 36. The scan lines (not shown in FIG. 4) and the metal layer 36 are also disposed on the first substrate 31. The protective layer 42 disposed between the data lines 32 and the black matrix layer 35 covers the scan lines (not shown in FIG. 4), the metal layer 36 and the data lines 32. The black matrix layer 35 is arranged above the data lines 32 along the same direction as the data lines 32. The lower surface 43 of the black matrix layer 35 extends to cover the two sides of the data lines 32 and partially overlaps the metal layer 36 in the corresponding pixel region. Analogically, the black matrix layer 35 may be arranged above the scan lines along the same direction as the scan lines as well. Furthermore, the lower surface 43 of the black matrix layer 35 extends to cover the two sides of the scan lines and partially overlaps the metal layer 36 in the corresponding pixel region.

In this exemplary embodiment, the black matrix layer is disposed on the TFT array substrate, and more specifically, the black matrix layer may overlap the scan lines and the data lines and be arranged between the data lines and the pixel electrodes. The conventional black matrix layer is disposed on the color filter substrate, while the black matrix layer and the pixel electrodes of the present invention are all disposed on the TFT array substrate. Accordingly, in the present invention, the area of the black matrix layer arranged to overlap the periphery regions of the pixel electrodes for compensating the alignment deviation caused by assembling the substrates could be decreased. Consequently, the light shielding area of the black matrix layer may be narrowed for increasing the aperture ratio of the liquid crystal display panel. As shown in FIG. 4, the pixel electrode 38 made of transparent conductive materials such as ITO or IZO (but not limited thereto) is disposed on the protective layer 42 in the corresponding pixel region. The black matrix 35 of the present invention has a tilted side 44 and a thickness. The pixel electrode 38 may extend to partially overlap the data lines 32 along the black matrix 35. Therefore, the horizontal distance between the pixel electrodes 38 and the data lines 32 can be decreased and the possible light-leaking region could also be reduced. Additionally, the black matrix layer 35 has a thickness and a dielectric constant smaller than the dielectric constant (substantially between 6 and 8) of the conventional protective layer. Consequently, the deposition of the black matrix layer 35 may increase the vertical distance between the pixel electrodes 38 and the data lines 32 for eliminating the coupling capacitance between the pixel electrodes and the data lines/the scan lines, and further stabilizing the peripheral electric field of the pixel electrodes. Therefore, the pixel electrodes 38 can partially extend and cover the black matrix layer 35 and the tilted side 44. The material of the black matrix layer 35 may include opaque material, and the material may be preferably an opaque material having the dielectric constant between 3 and 4, but is not limited thereto.

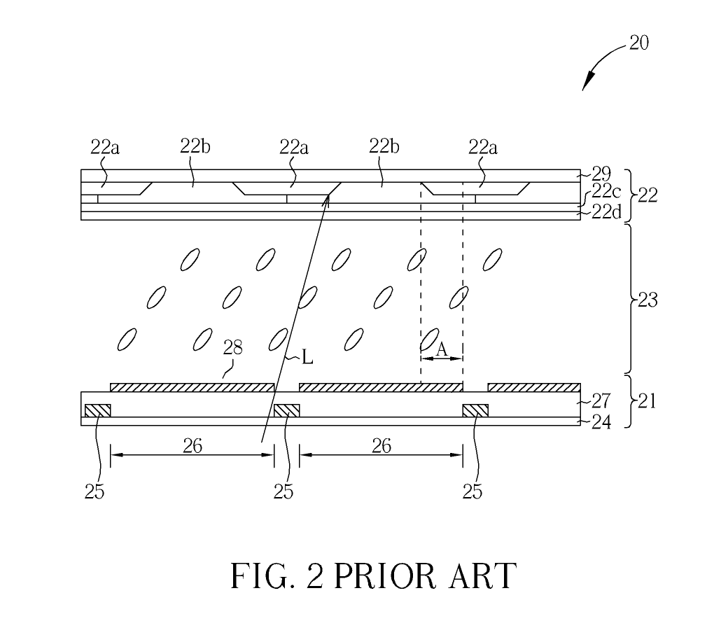

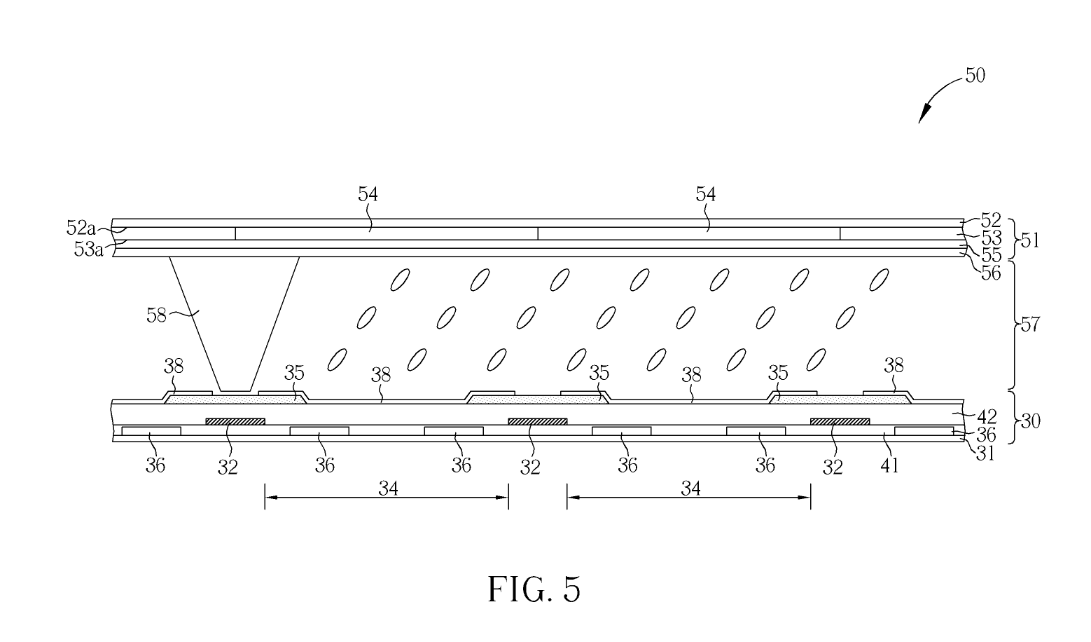

Please refer to FIG. 5. FIG. 5 illustrates a liquid crystal display panel according to an exemplary embodiment of the present invention. As shown in FIG. 5, the liquid crystal display panel 50 includes a first substrate, a second substrate and a liquid crystal layer: for example, the TFT array substrate 30, a color filter substrate 51 and a liquid crystal layer 57. Please refer to FIG. 3 and FIG. 4 together. The TFT array substrate 30 includes the first substrate 31, the gate insulating layer 41, a plurality of data lines 32, a plurality of scan lines (not shown in FIG. 5), a plurality of pixel regions 34 and the black matrix layer 35. The pixel regions 34 are the regions surrounded by the scan lines and the data lines 32, and each of the pixel regions 34 at least includes the TFT (not shown in FIG. 5), the pixel electrode 38 and the metal layer 36. In this exemplary embodiment, the black matrix layer 35 is disposed above the scan lines and the data lines 32, and the material of the black matrix layer 35 is preferably an opaque material having a dielectric constant between 3 and 4. Furthermore, the black matrix layer 35 may partially overlap the metal layer 36, and the pixel electrodes 38 may partially cover the black matrix layer 35. The difference between FIG. 2 and FIG. 5 is that the black matrix layer 35 having light-shielding effect is disposed on the TFT array substrate 30, and more specifically, between the corresponding data lines 32/scan lines and the corresponding pixel electrodes 38. The TFT array substrate 30 may further include the protective layer 42 disposed between the data lines 32 and the black matrix layer 35 covering the metal layer 36 and the data lines 32. The color filter substrate 51 disposed opposite to the TFT array substrate 30 includes a second substrate 52 and a color filter layer 53. The color filter layer 53 is disposed on a surface 52a of the second substrate 52. The color filter layer 53 includes a plurality of color filter units 54, and each of the color filter units 54 is disposed to corresponding to each of the pixel regions 34. The color filter substrate 51 may further include a protective layer 55 disposed on a surface 53a of the color filter layer 53 for releasing stress which could break the color filter layer 53. The material of the protective layer 55 is preferably a transparent insulating material such as resin, but is not limited thereto. The color filter substrate 51 may further include a transparent electrode layer 56. The transparent electrode layer 56 is disposed on the protective layer 55 in this exemplary embodiment, but is not limited thereto; the transparent electrode layer 56 may be disposed on a surface 53a of the color filter layer 53, i.e. between the protective layer 55 and the color filter layer 53. Moreover, the driving electric field generated between the transparent electrode layer 56 and the pixel electrode 38 may control the orientation of the liquid crystal molecules in the liquid crystal layer 57. The color filter substrate 51 may further include a plurality of photo spacers 58 disposed between the TFT array substrate 30 and the color filter substrate 51 for sustaining the interval between the two substrates. The liquid crystal layer 57 is disposed between the TFT array substrate 30 and the color filter substrate 51.

In conclusion, the present invention provides a liquid crystal display including a thin-film transistor (TFT) array substrate, a color filter substrate and a liquid crystal layer. The TFT array substrate includes a first substrate, a plurality of scan lines, a plurality of data lines, a plurality of pixel electrodes and a black matrix layer. The black matrix layer is disposed above the scan lines and the data lines, as opposed to the conventional black matrix layer disposed on the color filter substrate. Accordingly, the allowance of the alignment deviation caused during the assembling procedure of the substrates (the TFT array substrate and the color filter substrate) is increased. Therefore, the area of the black matrix layer arranged to overlap the periphery regions of the pixel electrodes for compensating the alignment deviation could be decreased; in other words, the redundant light shielding area of the black matrix layer may be reduced for increasing the aperture ratio of the liquid crystal display panel. Furthermore, the material of the black matrix layer is preferably an opaque material having a dielectric constant between 3 and 4. The disposition of the black matrix layer enables the edges of the pixel electrodes to extend so they can overlap the data lines for reducing the possible light-leaking region. This also eliminates the coupling capacitance between the pixel electrodes and the data lines/the scan lines and stabilizes the peripheral electric field of the pixel electrodes.

Those skilled in the art will readily observe that numerous modifications and alterations of the device and method may be made while retaining the teachings of the invention.

What is claimed is:

1. A liquid crystal display panel, comprising:
a thin-film transistor (TFT) array substrate, comprising:
a first substrate;
a plurality of scan lines arranged along a first direction on the first substrate;
a plurality of data lines arranged along a second direction on the first substrate, and the second direction crosses the first direction;
a plurality of pixel regions surrounded by the scan lines and the data lines; and
a black matrix layer disposed above the scan lines and the data lines;
a color filter substrate disposed opposite to the thin-film transistor array substrate, comprising:
a second substrate; and
a color filter layer disposed on a surface of the second substrate; and
a liquid crystal layer disposed between the thin-film transistor array substrate and the color filter substrate.

2. The liquid crystal display panel according to claim 1, wherein each of the pixel regions at least comprises a thin-film transistor disposed on the first substrate.

3. The liquid crystal display panel according to claim 1, wherein each of the pixel regions at least comprises a pixel electrode.

4. The liquid crystal display panel according to claim 3, wherein each of the pixel electrodes partially overlaps the black matrix layer, and the black matrix layer is disposed between each of the data lines and each of the pixel electrodes.

5. The liquid crystal display panel according to claim 4, wherein the black matrix layer comprises at least a tilted side, and each of the pixel electrodes partially overlaps the tilted side of the black matrix layer.

6. The liquid crystal display panel according to claim 1, wherein each of the pixel regions comprises a metal layer disposed on the first substrate.

7. The liquid crystal display panel according to claim 6, wherein the black matrix layer partially overlaps the metal layer.

8. The liquid crystal display panel according to claim 1, wherein the black matrix layer has a dielectric constant substantially between 3 and 4.

9. The liquid crystal display panel according to claim 1, wherein the thin-film transistor array substrate further comprises a protective layer disposed between the data lines and the black matrix layer.

10. The liquid crystal display panel according to claim 1, wherein the color filter substrate further comprises a transparent electrode layer disposed on a surface of the color filter layer.

11. The liquid crystal display panel according to claim 1, wherein the color filter substrate further comprises a plurality of photo spacers disposed between the thin-film transistor array substrate and the color filter substrate.

12. The liquid crystal display panel according to claim 1, wherein the color filter layer further comprises a plurality of color filter units, and each of the color filter units is disposed to corresponding to each of the pixel regions.
